(19) United States
(12) Patent Application Publication
(10) Pub. No.: US 2009/0121935 A1
(43) Pub. Date: May 14, 2009

(54) SYSTEM AND METHOD OF WEIGHTED AVERAGING IN THE ESTIMATION OF ANTENNA BEAMFORMING COEFFICIENTS

(75) Inventors: Pengfei XIA, Mountain View, CA (US); Chiu NGO, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: SAMSUNG ELECTRONICS CO., LTD., Suwon City (KR)

(21) Appl. No.: 12/118,502

(22) Filed: May 9, 2008

Related U.S. Application Data
(60) Provisional application No. 60/987,367, filed on Nov. 12, 2007.

(51) Int. Cl. H01Q 3/00

(52) U.S. Cl. 342/377

(57) ABSTRACT

A system and method of training transmit or receive antenna array is disclosed. The method includes: a) entering an antenna training mode, b) receiving a training sequence to form a channel matrix (Q), c) constructing an updated receive beamforming vector (w) via a weighted averaging method, the weighted averaging comprising:

$$w = {\sum }_{i = 1}^{K} {a}_{i} {q}_{i} ,$$

where qᵢ is the ith column of the matrix Q, aᵢ is the ith weighting coefficient, and K is the column size of the Q matrix, and d) sending another training sequence with the receive antenna array that has been beamformed with the updated w vector. The method further includes repeating b)-d) a plurality of times until the w vector is optimized. The method further includes beamforming the receive antenna array by the use of an optimized w vector.

### CROSS-REFERENCE TO RELATED APPLICATIONS

This application claims the benefit under 35 U.S.C. 119(e) of U.S. Provisional Application No. 60/987,367, filed on Nov. 12, 2007, which is incorporated by reference in its entirety.

### BACKGROUND OF THE INVENTION

1. Field of the Invention

The present invention relates to wireless networks, and in particular to improving of a signal-to-noise ratio (S/N) performance in a beamforming wireless system.

2. Description of the Related Technology

With the proliferation of high quality video, an increasing number of electronic devices, such as consumer electronic devices, utilize high definition (HD) video which can require multiple gigabit per second (Gbps) or more in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices that do not have the bandwidth to carry the uncompressed HD signals are connected to the network.

Recently, millimeter wave (mm-wave) Gbps communication is becoming a reality with technological advances and regulatory developments. For example, in early 2000, Federal Communications Commission (FCC) allocated a 7 GHz frequency band in the 57-64 GHz mm-wave band (also known as the 60 GHz frequency band) for unlicensed use. Opening of this large frequency band, combined with advances in CMOS technologies, makes it attractive to support gigabit per second (Gbps) wireless applications, such as uncompressed high definition video streaming and large file transfers.

One of the major challenges for mm-wave Gbps communications is the poor link budget, as a radio signal propagating in the mm-wave frequency band experiences significant path loss, reflection loss and other degradation. Also, the 60 GHz frequency band happens to be in an oxygen absorption band, which means that transmitted energy is quickly absorbed by oxygen molecules in the atmosphere, making the received signal even weaker.

Given the lossy nature of the radio channel as well as the limited CMOS performance at a mm-wave band, Gbps communications becomes very challenging. To improve the link quality, directional transmission is generally preferred. Due to the extremely short wavelength, it becomes possible and beneficial to integrate a large number (e.g., between 10 and 30) of antenna elements into an antenna array package. Antenna array based beamforming thus emerges as an attractive solution, featuring high beamforming gain and electronic steerability. In current practice of 60 GHz communications, a single RF chain is generally preferred for cost reduction consideration. For an orthogonal frequency division multiplexing (OFDM) based system, this implies that conventional digital beamforming which employs independent beamforming vectors across multiple subcarriers cannot be applied. Analog beamforming, which employs the same beamforming vector across multiple subcarriers, are used instead. An improvement in signal-to-noise (S/N) ratio can be achieved by periodically performing antenna trainings in a beamforming wireless system.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly.

In one embodiment, there is a method of training transmit or receive antenna array for improving a signal-to-noise ratio performance in a beamforming wireless system, the method comprising updating a first channel matrix (P) based at least partly on a received first training sequence, the first training sequence having been processed with an updated interim v, wherein the P represents a frequency domain channel viewed from a transmit station, updating an interim v, wherein the updating comprises estimating at least one of beamforming coefficients for the interim v by a weighted averaging of one of more elements of the updated P, the weighted averaging comprising

$$v = {\sum }_{i = 1}^{L} {b}_{i} {p}_{i} ,$$

wherein pᵢ is the ith column of the matrix P, bᵢ is the ith weighting coefficient to be designed, and L is the column size of the P matrix; and updating a second channel matrix (Q) based at least partly on a received second training sequence, the second training sequence having been processed with the updated interim w, wherein the Q represents a frequency domain channel viewed from a receive station, and updating an interim w, wherein the updating comprises estimating at least one of beamforming coefficients for the interim v by a weighted averaging of one of more elements of the updated Q, the weighted averaging comprising

$$w = {\sum }_{i = 1}^{K} {a}_{i} {q}_{i} ,$$

wherein qᵢ is the ith column of the matrix Q, aᵢ is the ith weighting coefficient, and K is the column size of the Q matrix; terminating the iterative antenna training algorithm; and beamforming a transmit or receive antenna array with the optimized beamforming vectors v and w.

In another embodiment, there is a method of training transmit or receive antenna array for improving a signal-to-noise ratio performance in a beamforming wireless system, the method comprising a) entering an antenna training mode; b) sending a training sequence with the transmit antenna array that has been beamformed with a transmit beamforming vector (v); c) receiving another training sequence to form an interim channel matrix (P); d) constructing an updated v vector via a weighted averaging, the weighted averaging comprising

$$v = {\sum }_{i = 1}^{L} {b}_{i} {p}_{i} ,$$

wherein pᵢ is the ith column of the matrix P, bᵢ is the ith weighting coefficient to be designed, and L is the column size of the P matrix; e) repeating b)-d) a plurality of times until the v vector is optimized; and f) beamforming the transmit antenna array with the optimized v vector.

In another embodiment, there is a method of training transmit or receive antenna array for improving a signal-to-noise ratio performance in a beamforming wireless system, the method comprising a) entering an antenna training mode; b) receiving a training sequence to form a channel matrix (Q); c) constructing an updated receive beamforming vector (w) via a weighted averaging, the weighted averaging comprising

$$w = {\sum }_{i = 1}^{K} {a}_{i} {q}_{i} ,$$

wherein qᵢ is the ith column of the matrix Q, aᵢ is the ith weighting coefficient, and K is the column size of the Q matrix; d) sending another training sequence with the receive antenna array that has been beamformed with the updated w vector; e) repeating b)-d) a plurality of times until the w vector is optimized; and f) beamforming the receive antenna array with the optimized w vector.

In another embodiment, there is an apparatus for data communication in a wireless network, the apparatus comprising one or more processors configured to a) send a training sequence via a transmit antenna array that has been beamformed with a transmit beamforming vector (v) in an antenna training mode, b) receive another training sequence to form an interim channel matrix (P), c) construct an updated v vector via a weighted averaging, the weighted averaging comprising

$$v = {\sum }_{i = 1}^{L} {b}_{i} {p}_{i} ,$$

wherein pᵢ is the ith column of the matrix P, bᵢ is the ith weighting coefficient to be designed, and L is the column size of the P matrix, d) repeat a)-c) a plurality of times until the v vector is optimized; and a transmit antenna array that is configured to transmit a data signal after having been beamformed with the optimized v vector.

In another embodiment, there is an apparatus for data communication in a wireless network, the apparatus comprising one or more processors configured to a) receive a training sequence to form a channel matrix (Q) in an antenna training mode, b) construct an updated receive beamforming vector (w) via a weighted averaging method, the weighted averaging comprising

$$w = {\sum }_{i = 1}^{K} {a}_{i} {q}_{i} ,$$

wherein qᵢ is the ith column of the matrix Q, aᵢ is the ith weighting coefficient, and K is the column size of the Q matrix, and c) send another training sequence with the receive antenna array that has been beamformed with the updated w vector, and d) repeat a)-c) a plurality of times until the w vector is optimized; and a receive antenna array that is configured to receive a data signal after having been beamformed with the optimized w vector.

In another embodiment, there is a method of training transmit or receive antenna arrays for improving a signal-to-noise ratio performance in a beamforming wireless system, the method comprising iteratively constructing optimized transmit and receive beamforming vectors by estimating interim receive and transmit beamforming vectors alternately until a preset level of convergence is achieved, wherein estimating the interim receive and transmit beamforming vectors comprises a weighted averaging involving one or more weighting coefficients multiplied by one or more columns of receive and transmit channel matrices; and beamforming transmit and receive antenna array by the use of the optimized transmit and receiving beamforming vectors.

### BRIEF DESCRIPTION OF THE DRAWINGS

FIG. 1 is a functional block diagram of an example analog beamforming wireless system implementing an embodiment of an iterative antenna training algorithm featuring a weighted averaging estimation of beamforming coefficients.

FIG. 2 is a block diagram illustrating an example training control module such as the ones shown in FIG. 1.

FIG. 3 shows a flowchart illustrating an example process for an iterative antenna training algorithm for constructing optimized transmit and receive beamforming vectors by estimating interim receive and transmit beamforming coefficients alternately until convergence.

FIG. 4 is a flowchart of an example process for an iterative beam acquisition protocol that implements an iterative antenna training algorithm such as the one illustrated in FIG. 3 for constructing receive and transmit beamforming vectors.

FIG. 5 is a graph illustrating a numerical study comparing the performance of the new iterative antenna training algorithm with the performance of a singular value decomposition (SVD) approach.

### DETAILED DESCRIPTION OF CERTAIN INVENTIVE EMBODIMENTS

Certain embodiments provide a method and system for improving a signal-to-noise ratio (S/N) performance in a beamforming wireless system. For illustration purposes, certain embodiments of an antenna training algorithm and protocol in a multi-carrier setup are described. The multi-carrier setup is assumed to employ orthogonal frequency division multiplexing (OFDM) modulation. The same algorithm and protocol can be easily applied to single carrier block transmission based schemes. As used herein, beamforming includes selecting or changing a receive/transmit directionality of an array of antennas. As will be described below, in certain embodiments, the beamforming can include optimizing and using one or both of transmit and receive beamforming vectors and channel matrices.

For high speed wireless communications over high frequency bands, high gain antennas are needed. Existing methods to enable high antenna gain includes use of directional antennas and use of antenna arrays. The latter is often preferred because a beam direction can be adaptively steered in an electronic manner. Antenna array beamforming (BF) provide increases in signal quality due to high directional antenna gain. Further, steering the transmitted signal in a dedicated direction extends the communication range.

A beamforming operation can be implemented in an analog domain as described in detail in U.S. patent application Ser. No. 11/881,978 (Applicant's Reference No. ARL07-WN06), titled “METHOD AND SYSTEM FOR ANALOG BEAMFORMING IN WIRELESS COMMUNICATION SYSTEMS,” filed on Jul. 30, 2007, herein incorporated by reference in its entirety. Beamforming can also be implemented in the digital domain. Digital beamforming is proposed in the 802.11n draft specification (“Draft Amendment to Standard for Information Technology-Telecommunications and Information Exchange between Systems-Local and Metropolitan Area Networks Specific Requirements—Part 11: Wireless LAN Medium Access control (MAC) and Physical Layer (PHY) Specifications: Enhancements for Higher Throughput,” IEEE P802.11n/D1.0, March 2006), which is herein incorporated by reference in its entirety.

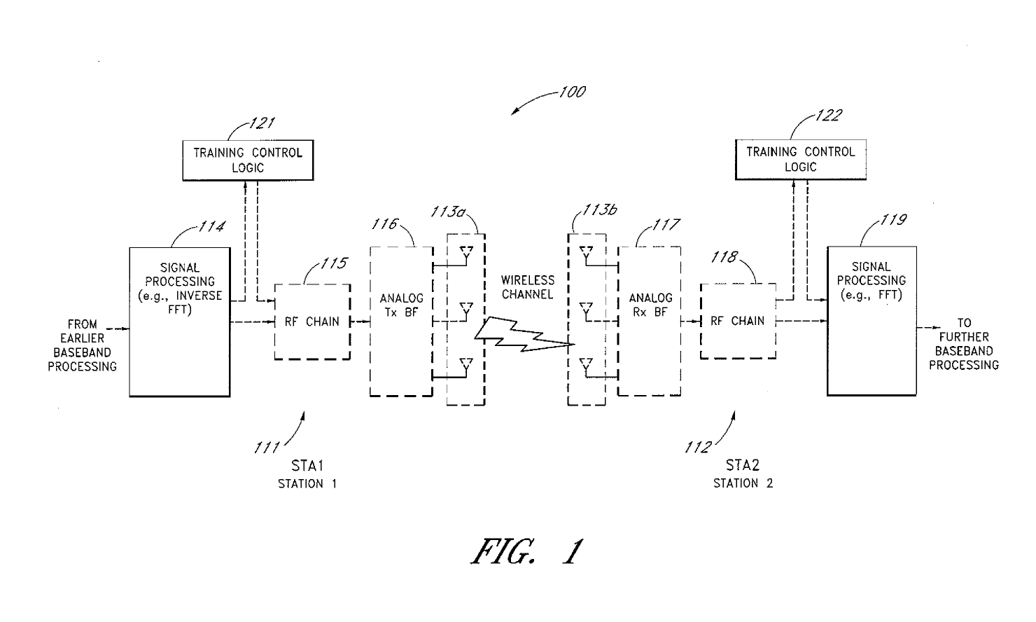

FIG. 1 is a functional block diagram of an example analog beamforming wireless system 100 implementing an embodiment of an iterative antenna training algorithm featuring a weighted averaging estimation of beamforming coefficients. It will be appreciated that the iterative antenna training (IAT) algorithm featuring the weighted averaging approach for estimating beamforming coefficients can also be implemented in a digital beamforming wireless system. The analog beamforming wireless system 100 includes two beamforming stations 111 and 112 (STA1 and STA2) providing an implicit beamforming framework. It will be also appreciated that the IAT algorithm can be easily adapted for beamforming stations providing an explicit feedback. The beamforming stations 111 and 112 comprise transceivers that include antenna arrays 113a and 113b, respectively.

The transmit (TX) function of the STA1 111 includes a signal processing module 114. The signal processing module 114 receives a baseband signal, that has undergone an earlier baseband processing, and performs an inverse Fast Fourier Transform (IFFT) which converts the signal from the frequency domain into a time domain digital signal. In certain embodiments, the signal processing module 114 can include a processor (not shown), e.g., a microprocessor, a digital signal processor (DSP), a programmable gate array (PGA) and the like, for performing the IFFT. The digital signal is then converted into an analog waveform by a digital to analog (D/A) function of an RF chain 115, and then transmitted to the STA2 112 via an antenna array 113a after analog beamforming by an analog TX BF function module 116. The STA1 111 also includes a training control module 121 that is used during an antenna training session to be discussed in detail below. During an antenna training session, the digital signal output from the signal processing module 114 is bypassed to the training control module 121 where at least part of an iterative antenna training algorithm for constructing antenna beamforming vectors is applied to the digital signal to generate a training sequence. The training sequence then flows into the RF chain 115, where it is converted into an analog waveform, and transmitted to the station 112 as described above.

The receive (RX) function of the station 112 includes an analog RX BF function module 117, which cooperatively with the analog TX BF function 116 provides analog beamforming. A signal transmitted from the station 111 is received by the station 112 via the antenna array 113b. The received signal flows into the analog RX BF function 117. The analog output signal from the analog RX BF function 117 is converted to a digital signal in an RF chain 118, and then converted to a frequency domain baseband signal by, for example, an FFT module inside a signal processing module 119. The frequency domain baseband signal is then output for a further baseband processing. The station 112 also includes a training control module 122 that is used during an antenna training session. During the antenna training session, a digital signal representing a training sequence received from the station 111 is bypassed to the training control module 122 where at least a part of an iterative antenna training algorithm for constructing a beamforming vector is applied.

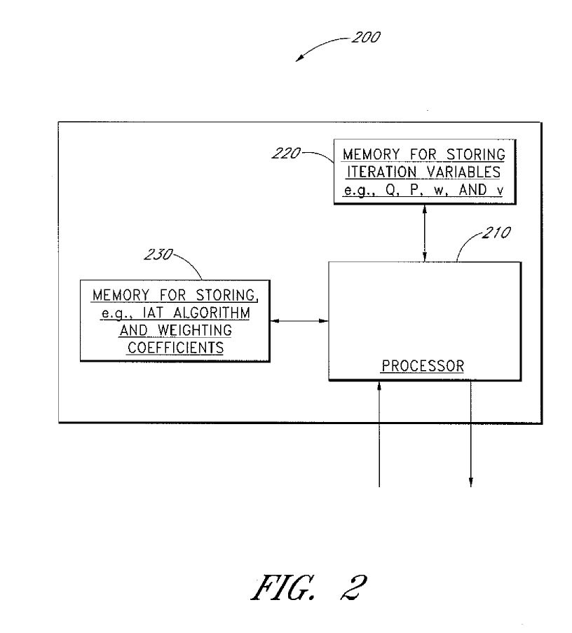

FIG. 2 is a block diagram illustrating an example training control module 200 such as the ones 121, 122 shown in FIG. 1. The example training control module 200 includes a processor 210, and a memory 220 for storing iteration variables such as a transmit channel matrix (P), a receive channel matrix (Q), and a transmit beamforming vector (v) and/or a receive beamforming vector (w) including elements of the Q and P matrices and beamforming (BF) coefficients for the w and v vectors. The training control module 200 further includes a memory 230 for storing a program including the iterative antenna training (IAT) algorithm featuring the weighted averaging approach for estimating beamforming vectors and the optimized weighting coefficients generated from the IAT algorithm. In certain embodiments, the memory 220 is a random access memory, and the memory 230 is a programmable read-only memory. In other embodiments, either the memory 220 or the memory 230 or both can include a flash memory or a hard disk drive.

It will be appreciated that various components of the training control module 200 are shown for illustration, and many different alternative embodiments are possible. For example, in certain embodiments, all or part of the IAT algorithm may be performed by the processor inside the signal processing module 114, 119 (FIG. 1) discussed above. In yet other embodiments, different parts of the IAT algorithm may be performed by different processors in a beamforming station. In yet other embodiments, the training control module may be part of the signal processing module 114, 119, rater than a separate module as shown in FIG. 2.

In certain embodiments, a symmetric transceiver structure exists for training, wherein both the transceiver and receiver are able to send and receive at a high speed, e.g., 60 GHz, frequency band. Transmission and reception can take place in a time division duplexing (TDD) manner, for example, wherein channel reciprocity can be used to reduce the training overhead. In practice, channel calibration is often needed to assure the channel reciprocity.

An adaptive beamforming process can be implemented by the TX BF function 116 and the RX BF function 117 (FIG. 1). The adaptive beamforming process can include beam searching and beam tracking procedures for implicit beamforming. An iterative beam searching process and an iterative beam tracking process can utilize the channel reciprocity to reduce the training overhead and improve system throughput. Detailed description of the iterative beam searching process and the iterative beam tracking process are given in the U.S. patent application Ser. No. 11/881,978, and is not repeated here.

### Iterative Antenna Training (IAT) Algorithm

An iterative antenna training (IAT) algorithm for optimizing the S/N ratio in a beamforming wireless system is now described. Specifically, the IAT algorithm includes a transmitter beamforming vector (BV) training and a receiver BV training, in which an optimized transmit BV and an optimized receive BV, respectively, are iteratively constructed. In certain embodiments, each iteration involves estimating interim receive and transmit BF coefficients alternately until the receive and transmit BF coefficients converge in a terminating iteration, thereby obtaining optimized beamforming vectors.

In some embodiments, a transmitter BV training is performed over a reverse multiple-input-multiple-output (MIMO) channel (e.g., from the RX station 112 to the TX station 111), while receiver BV training takes place over the forward MIMO channel (e.g., from the TX station 111 to the RX station 112). A construction of the optimized transmit BV is performed at the beamforming transmitter station 111, and a construction of the optimized receive BV is performed at the beamforming receiver station 112. As a result, there is no need to exchange the constructed BV, thereby reducing the signaling overhead.

Assuming an OFDM system with a total of K subcarriers, the following input-output relationship for analog beamforming can be adopted:

y(k)=w^{H}H(k)v·s(k)+n(k),∀k=1, . . . , K (1)

where s(k) is the data symbol transmitted on the kth subcarrier, H(k) is the multiple-input and multiple-output (MIMO) channel on the kth subcarrier of size Nᵣ×Nₜ, n(k) and y(k) are the additive white Gaussian channel noise and received data symbol on the kth subcarrier respectively, while w and v are the receive and transmit beamforming vectors, respectively. The w vector includes receive BF coefficients: w₁, w₂, . . . w_{Nr}. The v vector includes transmit BF coefficients: v₁, v₂, . . . v_{Nt}. Effectively, w^{H}H(k)v is the equivalent channel on the kth subcarrier. Notice that w and v are identical across multiple subcarriers due to analog beamforming.

The frequency domain matrix channel {H(k)}ₖ₌₁^{K} may be obtained from its time domain multi-tap channel realization. Particularly, let g_{i,j}:=[g_{i,j}[1],g_{i,j}[2], . . . , g_{i,j}[L],0,0, . . . , 0]^{T} be the multi-tap time domain channel between the ith receive and the jth transmit antenna, appended with zeros so that the vector g_{i,j} is of size K×1. The corresponding frequency domain channel response vector can be simply written as

h_{i,j}:=[h_{i,j}(1),h_{i,j}(2), . . . , h_{i,j}(K)]^{T}=F_{K}g_{i,j},

where F_{K} is the K×K Fourier matrix. The frequency domain matrix channel can be constructed as:

(H(k))_{i,j}=h_{i,j}(k), (2)

where (H(k))_{i,j} is the element on the ith row and jth column of matrix H(k).

Let S=diag(s₁,s₂, . . . , s_{K}) be the diagonal matrix containing all the K data symbols in one OFDM symbol. In a vector form, Eq. (1) can be recast as:

y=Sh_{c}+n

where h_{c}=[w^{H}H₁v, . . . , w^{H}H_{K}v]^{T} is the combined channel vector over each subcarrier across the entire OFDM symbol, y:=[y(1), . . . , y(K)]^{T} and n:=[n(1), . . . , n(K)]^{T}.

Pairwise error probability of the receiver with maximum likelihood detection can be obtained. Specifically, the error probability of deciding in favor of data matrix S^{e}, while the actual transmitted data matrix is S, can be upper bounded as:

$$\begin{matrix}{P}_{e} \leq P ( S -> {S}^{e} ) \\ \leq exp ( - {‖ ɛ {h}_{c} ‖}_{F}^{2} / 4 {N}_{0} )\end{matrix} \qquad ( 3 )$$

where ε=S−S^{e}, and ∥ε∥_{F}² is the Frobenius norm of the error matrix ε, N₀ is the noise variance. Averaging across all possible channel realizations, the average pairwise codeword distance square is obtained:

$${\overline{d}}^{2} := {E}_{∈} ( {h}_{c}^{H} {∈}^{H} ∈ {h}_{c} ) = {h}_{c}^{H} \cdot {E}_{∈} ( {∈}^{H} ∈ ) \cdot {h}_{c} = α {h}_{c}^{H} {h}_{c} \qquad ( 4 )$$

where E(.) is the statistical ensemble average, and E(ε^{H}ε)=αI thanks to ideal interleaving with α being a certain constant.

Instead of optimizing the pairwise error probability itself, an optimization of the average pairwise code-word distance is herein pursued. Realizing that h_{c}=P^{T}v with P:=[H₁^{T}w*, H₂^{T}w*,K, H_{K}^{T}w*] being a Nₜ×K matrix (w* being the complex conjugate of w), the following relationship is obtained:

h_{c}^{H}h_{c}=v^{H}P*P^{T}v. (5)

On the other hand,

$$\begin{matrix}{h}_{c}^{H} {h}_{c} = Trace ( {h}_{c} {h}_{c}^{H} ) \\ = Trace ( [ \begin{matrix}{w}^{H} {H}_{1} v \\ M \\ {w}^{H} {H}_{K} v\end{matrix} ] [ \begin{matrix}{v}^{H} {H}_{1}^{H} w & Λ & {v}^{H} {H}_{K}^{H} w\end{matrix} ] ) \\ = [ \begin{matrix}{w}^{H} {H}_{1} v & Λ & {w}^{H} {H}_{K} v\end{matrix} ] [ \begin{matrix}{v}^{H} {H}_{1}^{H} w \\ M \\ {v}^{H} {H}_{K}^{H} w\end{matrix} ] \\ = {w}^{H} {QQ}^{H} w\end{matrix} \qquad ( 6 )$$

where Q:=[H₁v,H₂v, . . . , H_{K}v] is a Nᵣ×K matrix.

As such, the receive channel matrix Q corresponds to the frequency domain channel viewed from the receiver side, and is a function of the transmit beamforming vector v. Similarly, the transmit channel matrix P corresponds to the frequency domain channel viewed from the transmitter side, and is a function of the receive beamforming vector w. The optimization problem thus can be cast in the two equivalent formulations, e.g.,

maximize w^{H}QQ^{H}w

subject to |w^{H}w|=1 (7)

maximize v^{H}P*P^{T}v

subject to |v^{H}v|=1 (8)

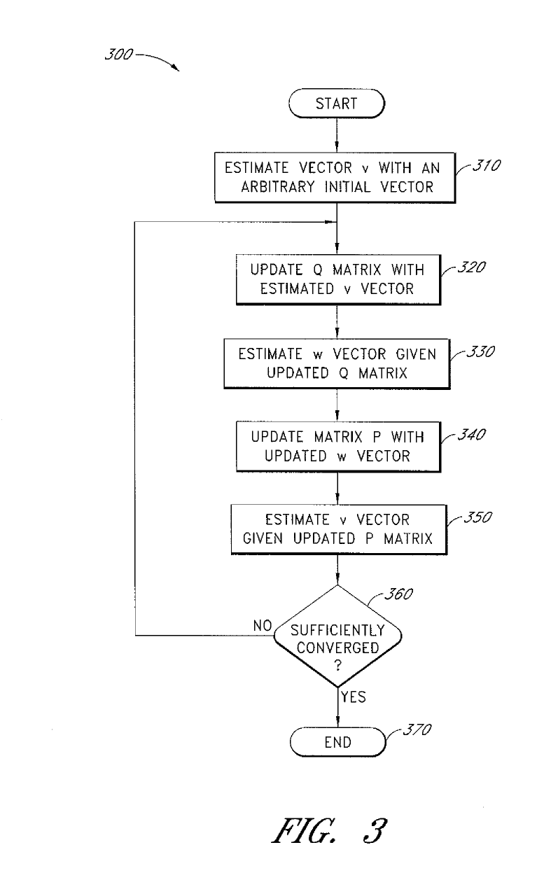

Realizing that P depends on w and Q depends on v, it can be deduced that neither w nor v can be optimized directly. On the other hand, the inter-connection between (7) and (8) leads to the iterative antenna training (IAT) algorithm illustrated by FIG. 3. FIG. 3 shows a flowchart illustrating an example process 300 for an IAT algorithm for constructing optimized transmit and receive beamforming vectors by estimating interim receive and transmit BF coefficients alternately until convergence. The process 300 starts at a state 310, where the transmit beamforming vector (BV) v is estimated with an arbitrary initial vector. This initial v vector is used as a seed for constructing optimized v and w as described below. Then, the process 300 enters an iterative loop at a state 320, where the receive channel matrix Q is updated with the newly estimated v vector. The process proceeds to a state 330, where the receive BV w with its receive BF coefficients is estimated using the updated Q matrix. The process 300 proceeds to a state 340, where the transmit channel matrix P is updated with the newly estimated w vector. The process 300 proceeds to a state 350, where the transmit BV v with its transmit BF coefficients is estimated using the updated P matrix. The process proceeds to a decision state 360, where it is queried whether there has been a sufficient convergence for the w and v vectors. A sufficient convergence is one of several design parameters that can be preset in the IAT algorithm. For example, in certain embodiments, a convergence is deemed sufficient when there is less than 1-2% maximum difference in two consecutive estimations of BF coefficients. Another possible condition of terminating the iteration includes terminating the iteration after a maximum number (e.g., 10) of iterations. If the answer at decision state 360 is YES, the process ends at state 370. If the answer is NO, on the other hand, the process 300 continues by looping back to the state 320, where the Q matrix is updated with the v vector estimated at the state 350.

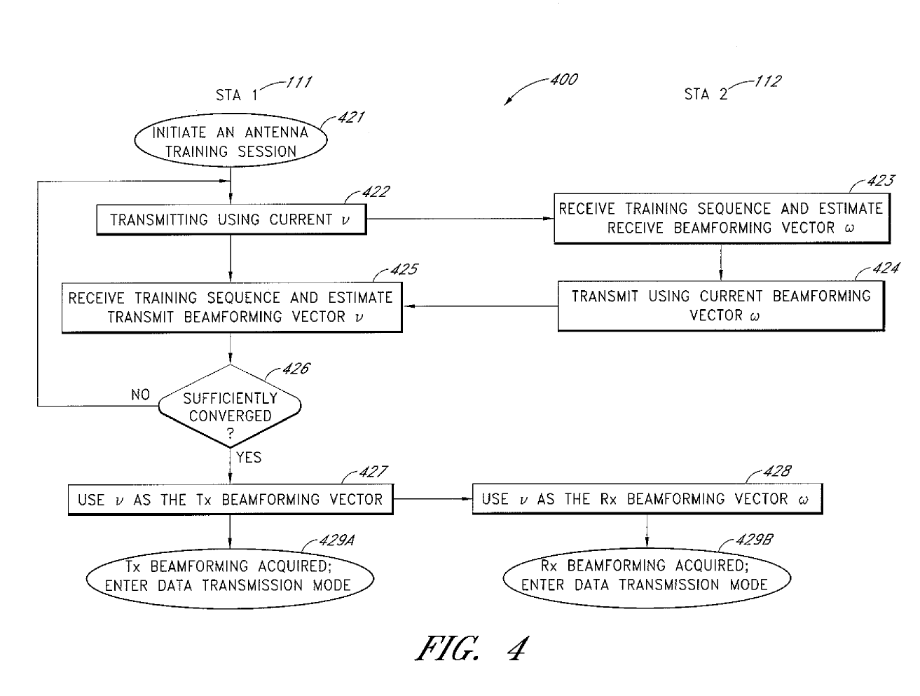

FIG. 4 is a flowchart of an example process 400 for an iterative beam acquisition protocol that implements an iterative antenna training (IAT) algorithm such as the one shown in FIG. 3 for constructing receive and transmit beamforming vectors (e.g., w and v) between two wireless transceivers (e.g., stations 111 and 112 in FIG. 1). The process 400 starts at a state 421, where a transceiver station STA1 111 enters an antenna training mode. In certain embodiments, a transceiver performs an antenna training session with another transceiver station in a pre-scheduled manner, e.g., every 5 to 50 ms while the actual time period depends on the communication environments. In other embodiments, an antenna training session is initiated in an on-demand basis, e.g., whenever a channel change occurs or when a link is declared lost. In certain embodiments, a typical antenna training session can last from several tens of microseconds to several hundreds of microseconds. The process 400 proceeds to a state 422, where the station 111 enters into a transmit mode as a transmitter (TX) and transmits a training sequence using the current transmit beamforming vector v. The process proceeds to a state 423, where the training sequence originating from the station 111 is received at a station 112, operating in a receive mode as a receiver (RX), and the received training sequence is used to estimate an interim receive beamforming vector w. The process proceeds to a state 424, where the station 112 then switches to a transmit mode as a TX and transmits a training sequence using the current interim w vector. The process proceeds to a state 425, where the training sequence originating from the station 112 is received at the station 111, operating now in RX mode, and the received training sequence is used to estimate an interim transmit beamforming vector v.

The states 422-425 are repeated Nᵢₜₑᵣ times before converging to the final transmit and receive beamforming vectors, indicating that they are optimized. In each iteration, it is determined at a decision state 426 if a sufficient convergence and/or a beam-acquired state has been achieved. A transmitting device and a receiving device are said to fall in a ‘beam-acquired state’ if the iterative antenna training is deemed converged after a number of iterations. If not, the process loops back to the state 422; otherwise, the process proceeds to a state 427, where the station 111 now operating in a transmit mode uses the beamforming vector was a transmit beamforming vector and transmits the TX beamforming training sequence to the station 112. The process then proceeds to a state 428, where the station 112 now operating in RX mode uses the beamforming training sequence to determine a final RX beamforming vector w. At a state 429A, the station 111 exits the antenna training session and enters a data transmission mode using the final v vector. The process 400 proceeds from state 428 to a state 429B, where the station 112 likewise exits the antenna training session and enters a data receiving mode using the final w vector.

### IAT Algorithm Featuring a Weighted Averaging for Estimating Beamforming Coefficients

Methods for optimizing v and w are now described. This subsection will focus on optimizing w, but the methods discussed in this subsection apply equally well toward optimizing v.

Optimizing w given Q, or solving Eq. (7), can be completed by a standard singular value decomposition (SVD) approach such as an eigen-decomposition (ED) technique. However, the SVD approach involves a high computation complexity. For example, the computational complexity of the SVD approach is on the order of N̂3, where N is the dimension of the data matrix to be processed.

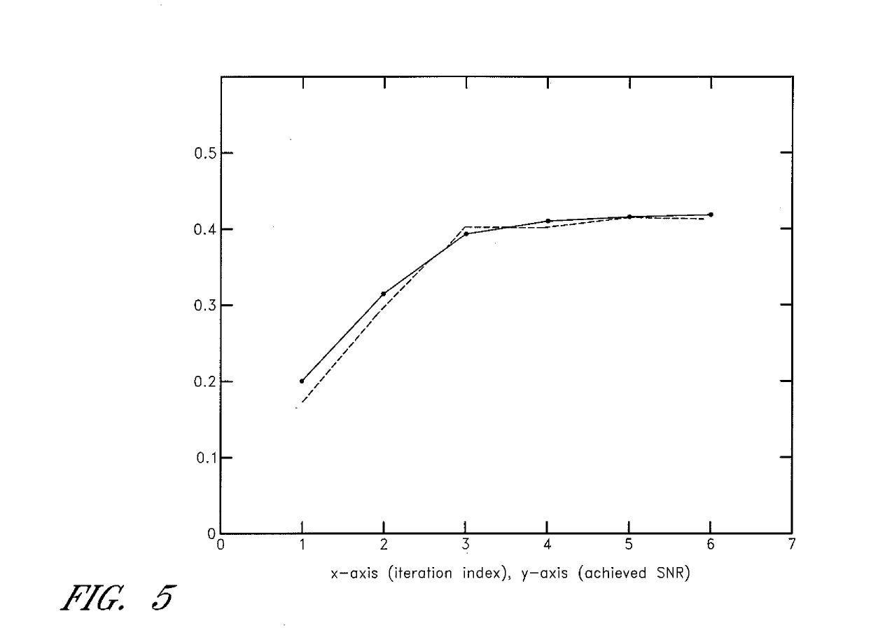

To reduce the computation complexity, the following weighted averaging approach can be adopted. Remembering that Q:=[H₁v,H₂v, . . . , H_{K}v], we may complete optimizing w in the IAT algorithm as:

$$w = {\sum }_{i = 1}^{K} {a}_{i} {H}_{i} v = {\sum }_{i = 1}^{K} {a}_{i} {q}_{i} \qquad ( 9 )$$

where qᵢ is the ith column of matrix Q, aᵢ is the ith weighting coefficient to be designed, and K is the column size of the Q matrix. Of course, a vector normalization is needed in order to meet the unit norm constraint in Eq. (7). Eq. (9) forms the interim beamforming vector w by weighted averaging of qᵢ across all subcarriers. In some embodiments, the weighting coefficients, aᵢ, are 1 for all values of i=1, . . . , K. In other embodiments, aᵢ=1 for i=J, and aᵢ=0 for all other values of i ranging between 1 and K, wherein q_{J}, the J^{th} column of the Q matrix, is the column with the largest vector norm compared to vector norms of other columns of the Q matrix. In yet other embodiments, aᵢ=1 for i=J1, J2, . . . , or JM and aᵢ=0 for all other values of i ranging between 1 and L, wherein q_{J1}, q_{J2}, . . . , q_{JM}, the J1^{th}, J2^{th}, . . . , JM^{th} column of the Q matrix, are the M columns with the M largest vector norm compared to vector norms of other columns of the Q matrix. It can be expected that a weighted averaging based computation as in Eq. (9) can incur a loss of optimality. However, as is illustrated by FIG. 5, the achieved performance actually is similar compared to the original algorithm when ED based computation is used. In the proposed weighted averaging based computation, no matrix multiplication is needed once Q is obtained.

Similarly, we may complete optimizing v in the IAT algorithm as:

$$v = {\sum }_{i = 1}^{L} {b}_{i} {H}_{i} w = {\sum }_{i = 1}^{L} {b}_{i} {p}_{i} \qquad ( 10 )$$

where pᵢ is the ith column of matrix P, bᵢ is the ith weighting coefficient to be designed, and L is the column size of the P matrix. Eq. (10) is also subject to the vector normalization requirement. Eq. (10) forms the interim beamforming vector v by weighted averaging of pᵢ across all subcarriers. In some embodiments, the weighting coefficients, bᵢ, are 1 for all values of i=1, . . . , L. In other embodiments, bᵢ=1 for i=J, and bᵢ=0 for all other values of i ranging between 1 and L, wherein p_{J}, the J^{th} column of the P matrix, is the column with the largest vector norm compared to vector norms of other columns of the P matrix. In yet other embodiments, bᵢ=1 for i=J1, J2, . . . , or JM, and bᵢ=0 for all other values of i ranging between 1 and L, where p_{J1}, p_{J2}, . . . , p_{JM}, the J1^{th}, J2^{th}, . . . , JM^{th} column of the P matrix, are the M columns with the M largest vector norm compared to vector norms of other columns of the P matrix. In general, the aᵢ and bᵢ weighting coefficients may be different.

As discussed above, the weighting coefficients, a₁, a₂, . . . , a_{K}, and a=b₁, b₂, . . . , b_{L} are design parameters to be determined. Determination of the design parameter(s) involves a tradeoff between complexity (in choosing the parameters) and performance, e.g., speed of convergence, and/or S/N ratio after a fixed number of iterations. In certain embodiments, the weighting coefficients are determined by a designer after performing study and optimization in advance and do not change during the lifecycle of the product. In such embodiments, the same weighting coefficients are used repeatedly for training sessions. In other embodiments, the design parameters may be changed, e.g., by a processor in the product, when it is determined that changing the parameter(s) improves the tradeoff between complexity and performance.

### Performance Evaluation

FIG. 5 is a graph illustrating a numerical study comparing the performance of the new iterative antenna training algorithm with the performance of a singular value decomposition (SVD) approach. For the numerical study, a simple multi-path MIMO block fading channel with exponential delay spread was adopted. For each tap, the MIMO channel coefficients are independently and identically distributed (i.i.d.) circularly complex Gaussian distributed with zero mean and unit variance, and the multiple taps are independent from each other as well. For simulation purpose, L=8 is assumed with OFDM block size K=64, and the delay exponent is set α=−0.75.

In FIG. 5, the x-axis represents the multiple subcarriers, and the y-axis is the achieved gain per subcarrier. The dashed curve 501 represents the achieved SNR performance by the traditional SVD based method, while the solid curve 502 represents the achieved SNR performance by the proposed weighted averaging method, in which all weighting coefficients are set to 1. It can be seen that weighted averaging method achieves similar performance while the computation complexity is much smaller. For a practical scenario with a large number of antenna elements (a large K), the weighted averaging based computation can provide significant computation complexity reduction relative to its counterpart.

### CONCLUSION

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A method of training transmit or receive antenna array for improving a signal-to-noise ratio performance in a beamforming wireless system, the method comprising:
iteratively constructing an optimized transmit beamforming vector (v) and an optimized receive beamforming vector (w) via an iterative antenna training algorithm in an antenna training mode, the iterative antenna training algorithm comprising:
updating a first channel matrix (P) based at least partly on a received first training sequence, the first training sequence having been processed with an updated interim v, wherein the P represents a frequency domain channel viewed from a transmit station,
updating an interim v, wherein the updating comprises estimating at least one of beamforming coefficients for the interim v by a weighted averaging of one of more elements of the updated P, the weighted averaging comprising
$$v = {\sum }_{i = 1}^{L} {b}_{i} {p}_{i} ,$$
wherein:
pᵢ is the ith column of the matrix P,
bᵢ is the ith weighting coefficient to be designed, and
L is the column size of the P matrix; and
updating a second channel matrix (Q) based at least partly on a received second training sequence, the second training sequence having been processed with the updated interim w, wherein the Q represents a frequency domain channel viewed from a receive station, and
updating an interim w, wherein the updating comprises estimating at least one of beamforming coefficients for the interim v by a weighted averaging of one of more elements of the updated Q, the weighted averaging comprising
$$w = {\sum }_{i = 1}^{K} {a}_{i} {q}_{i} ,$$
wherein:
qᵢ is the ith column of the matrix Q,
aᵢ is the ith weighting coefficient, and
K is the column size of the Q matrix;
terminating the iterative antenna training algorithm; and
beamforming a transmit or receive antenna array with the optimized beamforming vectors v and w.

2. The method of claim 1, further comprising storing the optimized v vector in a memory in the transmit station and storing the optimized w vector in a memory in the receive station.

3. The method of claim 1, wherein the iterative antenna training algorithm is terminated after a preset level of convergence or a beam-acquired state is achieved.

4. The method of claim 3, wherein the preset level of convergence is reached when there is less than 2% maximum difference in two consecutive estimations of beamforming coefficients.

5. The method of claim 1, wherein the iterative antenna training algorithm is terminated after a preset number of iterations.

6. The method of claim 1, further comprising providing an arbitrary initial v or w vector at the first iteration.

7. The method of claim 1, further comprising:
exiting the training mode after the iterative antenna training algorithm is terminated;
entering a data communication mode; and
processing a data signal using the optimized v vector and the optimized w vector.

8. The method of claim 1, wherein:
P:=[H₁q, . . . Hⱼq, . . . , H_{K}q]; and
Q:[H₁p, . . . Hⱼp, . . . , H_{K}p],
wherein Hⱼ represents a multiple-input and multiple-output (MIMO) channel on the j^{th} subcarrier.

9. A method of training a transmit antenna array for improving a signal-to-noise ratio performance in a beamforming wireless system, the method comprising:
a) entering an antenna training mode;
b) sending a training sequence with the transmit antenna array that has been beamformed with a transmit beamforming vector (v);
c) receiving another training sequence to form an interim channel matrix (P);
d) constructing an updated v vector via a weighted averaging, the weighted averaging comprising
$$v = {\sum }_{i = 1}^{L} {b}_{i} {p}_{i} ,$$
wherein:
pᵢ is the ith column of the matrix P,
bᵢ is the ith weighting coefficient to be designed, and
L is the column size of the P matrix;
e) repeating b)-d) a plurality of times until the v vector is optimized; and
f) beamforming the transmit antenna array with the optimized v vector.

10. The method of claim 9, wherein the construction of the updated v vector is part of an iterative antenna training algorithm for constructing the optimized v vector.

11. The method of claim 10, wherein the iterative antenna training algorithm is terminated after one of a preset level of convergence, a preset number of iterations, and a beam-acquired state.

12. The method of claim 10, further comprising:
exiting the training mode after the iterative antenna training algorithm is terminated; and
entering a data communication mode.

13. The method of claim 9, wherein the weighted averaging comprises a weighted averaging of pᵢ across a plurality of subcarriers.

14. The method of claim 9, wherein the weighting coefficients are predetermined at a product development stage.

15. The method of claim 9, wherein bᵢ=1 for all values of i ranging between 1 and L.

16. The method of claim 9, wherein bᵢ=1 for i=J, and bᵢ=0 for all other values of i ranging between 1 and L, wherein p_{J}, the J^{th} column of the P matrix, is the column with the largest vector norm compared to vector norms of other columns of the P matrix.

17. The method of claim 9, wherein bᵢ=1 for i=J1, J2, . . . , or JM, and bᵢ=0 for all other values of i ranging between 1 and L, wherein P_{J1}, p_{J2}, . . . , p_{JM}, the J1^{th}, J2^{th}, . . . , JM^{th} column of the P matrix, are the M columns with the M largest vector norm compared to vector norms of other columns of the P matrix.

18. A method of training a receive antenna array for improving a signal-to-noise ratio performance in a beamforming wireless system, the method comprising:
a) entering an antenna training mode;
b) receiving a training sequence to form a channel matrix (Q);
c) constructing an updated receive beamforming vector (w) via a weighted averaging, the weighted averaging comprising
$$w = {\sum }_{i = 1}^{K} {a}_{i} {q}_{i} ,$$
wherein:
qᵢ is the ith column of the matrix Q,
aᵢ is the ith weighting coefficient, and
K is the column size of the Q matrix;
d) sending another training sequence with the receive antenna array that has been beamformed with the updated w vector;
e) repeating b)-d) a plurality of times until the w vector is optimized; and
f) beamforming the receive antenna array with the optimized w vector.

19. The method of claim 18, wherein the construction of the updated w vector is part of an iterative antenna training algorithm for constructing the optimized v vector.

20. The method of claim 19, wherein the iterative antenna training algorithm is terminated after one of a preset level of convergence, a preset number of iterations, and a beam-acquired state.

21. The method of claim 18, wherein the weighted averaging comprises a weighted averaging of qᵢ across a plurality of subcarriers.

22. The method of claim 18, wherein the weighting coefficients are predetermined at a product development stage.

23. The method of claim 18, wherein aᵢ=1 for all values of i ranging between 1 and K.

24. The method of claim 18, wherein aᵢ=1 for i=J, and bᵢ=0 for all other values of i ranging between 1 and L, wherein q_{J}, the J^{th} column of the Q matrix, is the column with the largest vector norm compared to vector norms of other columns of the Q matrix.

25. The method of claim 18, wherein aᵢ=1 for i=J1, J2, . . . , or JM, and aᵢ=0 for all other values of i ranging between 1 and L, wherein q_{J1}, q_{J2}, . . . , q_{JM}, the J1^{th}, J2^{th}, . . . , JM^{th} column of the Q matrix, are the M columns with the M largest vector norm compared to vector norms of other columns of the Q matrix.

26. An apparatus for data communication in a wireless network, the apparatus comprising:
one or more processors configured to:
a) send a training sequence via a transmit antenna array that has been beamformed with a transmit beamforming vector (v) in an antenna training mode,
b) receive another training sequence to form an interim channel matrix (P),
c) construct an updated v vector via a weighted averaging, the weighted averaging comprising
$$v = {\sum }_{i = 1}^{L} {b}_{i} {p}_{i} ,$$
wherein:
pᵢ is the ith column of the matrix P,
bᵢ is the ith weighting coefficient to be designed, and
L is the column size of the P matrix,
d) repeat a)-c) a plurality of times until the v vector is optimized; and
a transmit antenna array that is configured to transmit a data signal after having been beamformed with the optimized v vector.

27. The apparatus of claim 26, further comprising a memory for storing one or more weighting coefficients for the weighted averaging.

28. An apparatus for data communication in a wireless network, the apparatus comprising:
one or more processors configured to:
a) receive a training sequence to form a channel matrix (Q) in an antenna training mode,
b) construct an updated receive beamforming vector (w) via a weighted averaging method, the weighted averaging comprising
$$w = {\sum }_{i = 1}^{K} {a}_{i} {q}_{i} ,$$
wherein
qᵢ is the ith column of the matrix Q,
aᵢ is the ith weighting coefficient, and
K is the column size of the Q matrix, and
c) send another training sequence with the receive antenna array that has been beamformed with the updated w vector, and
d) repeat a)-c) a plurality of times until the w vector is optimized; and
a receive antenna array that is configured to receive a data signal after having been beamformed with the optimized w vector.

29. A method of training transmit or receive antenna array for improving a signal-to-noise ratio performance in a beamforming wireless system, the method comprising:
iteratively constructing optimized transmit and receive beamforming vectors by estimating interim receive and transmit beamforming vectors alternately until a preset level of convergence is achieved,
wherein estimating the interim receive and transmit beamforming vectors comprises a weighted averaging involving one or more weighting coefficients multiplied by one or more columns of receive and transmit channel matrices; and
beamforming transmit and receive antenna array by the use of the optimized transmit and receiving beamforming vectors.
